(19) United States
(12) Patent Application Publication
(10) Pub. No.: US 2020/0206715 A1
(43) Pub. Date: Jul. 2, 2020

(54) POROUS BORON NITRIDE

(71) Applicant: IP2IPO INNOVATIONS LIMITED, London (GB)

(72) Inventors: Camille PETIT, London (GB); Sophia MARCHESINI, London (GB)

(21) Appl. No.: 16/494,132

(22) PCT Filed: Mar. 16, 2018
(86) PCT No.: PCT/GB2018/050686

§ 371 Date: Sep. 13, 2019

(30) Foreign Application Priority Data
Mar. 17, 2017 (GB) 1704321.7

(51) Int. Cl. B01J 20/02; C01B 21/064; B01J 20/28; B01J 20/30; B01D 53/04; B01D 17/02; C02F 1/28

(52) U.S. Cl. CPC B01J 20/0248; C02F 2101/32; B01J 20/28045; B01J 20/28064; B01J 20/28071; B01J 20/2808; B01J 20/28083; B01J 20/3078; B01D 53/04; B01D 17/0202; C02F 1/281; C01P 2002/02; C01P 2006/12; C01P 2006/14; C01P 2002/72; C01P 2004/04; B01D 2253/10; B01D 2253/306; B01D 2253/311; C01B 21/0646

(57) ABSTRACT

A method for producing a porous boron nitride material. The method comprises providing a mixture comprising a first nitrogen-containing organic compound, a second nitrogen-containing organic compound and a boron-containing compound. The method further comprises heating the mixture to cause thermal degradation of the mixture and form a porous boron nitride material.

### CROSS-REFERENCE TO RELATED APPLICATIONS

This application is a 35 U.S.C. § 371 filing of International Application No. PCT/GB2018/050686, filed on Mar. 16, 2018, which claims priority to Great Britain patent application number 1704321.7, filed Mar. 17, 2017. The entire contents of these applications are incorporated by reference herein, in their entirety.

### FIELD OF THE INVENTION

The present invention relates to a method for producing a porous boron nitride material, a porous boron nitride material per se, and methods for the separation of mixtures of liquids and gasses. The invention has particular, but not exclusive, application in the production of boron nitride materials having tunable porosity characteristics.

### BACKGROUND

Porous materials have utility in a variety of applications, including gas storage, water and air treatments; separation of gases and liquids, drug delivery, catalysis, etc. The properties, particularly porosity characteristics (e.g. surface area, pore volume, etc.), of materials suitable for a given application are typically specific to that application. The properties required for a porous material for use in a given application are well known to those of skill in the art. It would be desirable to be able to reliably produce materials having tunable (i.e. selectively adjustable) porosity characteristics.

Boron nitride-based porous materials (e.g. amorphous and/or turbostratic materials) have a number of useful properties, including high chemical resistance, thermal conductivity and mechanical resistance, making those materials ideal candidates for use in a variety of applications.

Boron nitride may be produced by heating a mixture of a nitrogen-containing precursor and a boron-containing precursor in a thermal degradation reaction in an inert atmosphere, such as nitrogen (N₂), or in an ammonia/hydrogen (NH₃/H₂) or nitrogen/hydrogen N₂/H₂ mixture. Existing methods for production of porous boron nitride materials include the use of tem plating methods. By way of example, porous zeolite templates may be infiltrated with propylene to form a so-called carbonaceous replica bound to the structure of the zeolite. The zeolite template can then be dissolved using hydrofluoric acid. The carbonaceous replica can then be impregnated with polyborazylene, and thereafter pyrolysed to form a boron nitride material. Typically, washing and other processing steps are thereafter employed to remove as much carbonaceous material as possible.

However, existing methods may yield porous boron nitride materials having a substantial level of impurities (such as carbon-based impurities). Carbon-based impurities in the material may thermally degrade upon exposure of the material to high temperature, thereby generating weaknesses (e.g. structural weaknesses) in the material, thus impairing its proper function. Additionally, existing methods often rely on the use of expensive reagents and/or starting materials. Moreover, templating methods may provide limited control over the pore structure in boron nitride materials (i.e. materials having selectively adjustable porosity characteristics) and/or may typically be limited to unimodal pore size distribution.

It is desirable to provide an improved production technique and/or improved porous boron nitride material, and/or otherwise to obviate and/or mitigate one or more of the disadvantages with known production techniques and/or porous boron nitride materials, whether identified herein or otherwise.

### SUMMARY

According to a first aspect of the present invention there is provided a method for producing a porous boron nitride material (optionally an amorphous and/or turbostratic porous boron nitride material, such as an amorphous porous boron nitride material), the method comprising:
providing a mixture comprising a first nitrogen-containing compound (optionally an organic compound), a second nitrogen-containing compound (optionally an organic compound) and a boron-containing compound; and
heating the mixture to cause thermal degradation of the mixture and form an amorphous porous boron nitride material.

According to a second aspect of the present invention, there is provided a porous boron nitride material (optionally an amorphous and/or turbostratic porous boron nitride material, such as an amorphous porous boron nitride material) obtainable by the method according to the first aspect.

According to a third aspect of the present invention, there is provided a method for separating a mixture of gasses, the method comprising:
exposing a mixture comprising a first gaseous component and a second gaseous component to a porous boron nitride material (optionally an amorphous and/or turbostratic porous boron nitride material, such as an amorphous porous boron nitride material) according to the second aspect of the present invention.

According to a fourth aspect of the present invention, there is provided a use of a porous boron nitride material (optionally an amorphous and/or turbostratic porous boron nitride material, such as an amorphous porous boron nitride material) according to the second aspect of the present invention in the separation of a mixture comprising first and second gaseous components.

According to a fifth aspect of the present invention, there is provided a method for separating a mixture of a first liquid component and a second liquid component, the method comprising:
exposing a mixture comprising said first liquid component and said second liquid component to a porous boron nitride material (optionally an amorphous and/or turbostratic porous boron nitride material, such as an amorphous porous boron nitride material) according to the second aspect of the present invention.

According to a sixth aspect of the present invention, there is provided a use of a porous boron nitride material (optionally an amorphous and/or turbostratic porous boron nitride material, such as an amorphous porous boron nitride material) according to the second aspect of the present invention in the separation of a mixture comprising first and second liquid components.

### BRIEF DESCRIPTION OF THE FIGURES

The invention will now be further described, by way of example only, with reference to the accompanying examples and figures, in which:

FIGS. 1 and 2 show the results of thermal degradation analyses;

FIG. 3 shows the results of oxidation studies under air flow at high temperatures;

FIGS. 4 and 5 show the results of nitrogen isotherm analyses;

FIGS. 6 and 7 show the results for pore volume analyses;

FIG. 8 shows the results for low pressure (about 100 kpa; about 1 bar) and low temperature gas sorption analyses;

FIG. 9 shows the results for high pressure (about 2000 kpa; 20 bar) gas sorption analyses at various temperatures;

FIG. 10 shows the results for surface elemental (XPS) analyses;

FIGS. 11 and 12 show results for powder X-ray diffraction (XRD) analyses;

FIGS. 13 and 14 show results for Fourier Transform Infrared Spectroscopy (FTIR);

FIGS. 15 and 16 shows results for Transmission Electron Microscopy (TEM) analyses;

FIG. 17 shows the results of surface area analyses;

FIGS. 18 and 19 show the results of nitrogen isotherm analyses;

FIG. 20 shows the results for surface elemental (XPS) analyses;

FIG. 21 shows the results of nitrogen isotherm analyses; and

FIG. 22 shows results for Fourier Transform Infrared Spectroscopy (FTIR).

### DEFINITIONS

The term “amorphous material” (e.g. the amorphous porous boron nitride material) may be understood to be a material with predominantly amorphous character. Such a material does not have long-range crystalline order (i.e. the bulk properties of the material are substantially non-crystalline), although parts of the material may exist in a crystalline form (i.e. short-range order may exist). Crystallinity may be assessed using X-ray diffraction, with broad peaks and/or low intensities indicating lower or poorer crystallinity than narrow peaks and/or higher intensities.

The term “turbostratic material” (e.g. the turbostratic porous boron nitride material) may be understood to be a material with partial crystalline character in which the planes (e.g. basal planes) of the crystalline structure are out-of-alignment.

Visual inspection of Transmission Electron Microscopy (TEM) scans may be used to differentiate amorphous and/or turbostratic porous boron nitride materials from crystalline materials (such as crystalline nanosheets). In TEM analysis, amorphous porous materials resemble sponges (materials with sparse density and many open pores), whereas crystalline materials may resemble smooth plate-like structures. Alternatively or additionally, selected area diffraction can be used to confirm that the material is amorphous and/or turbostratic.

The concept of crystallinity is well understood to those of skill in the art, as are the meaning of the terms “amorphous” and “turbostratic”.

The term “nitrogen-containing organic compound” relates to a compound comprising at least one nitrogen atom and at least one carbon atom in its molecular structure.

“Boron-containing compound” relates to a compound comprising at least one boron atom in its molecular structure.

The term “thermal degradation” may be understood to mean the breaking down of a compound upon exposure to heat into components which do not recombine on cooling. Thermal degradation may take place by a number of pathways, such as pyrolysis, oxidation, etc.

The term “room temperature” may be understood to mean about 20° C.

The term “mesopore” refers to pores having a diameter between about 2 and 50 nm.

The term “micropore” refers to pores having a diameter less than about 2 nm.

### DETAILED DESCRIPTION

According to a first aspect of the present invention there is provided a method for producing a porous boron nitride material (optionally an amorphous and/or turbostratic porous boron nitride material, such as an amorphous porous boron nitride material), the method comprising:
providing a mixture comprising a first nitrogen-containing compound (optionally an organic compound), a second nitrogen-containing compound (optionally an organic compound) and a boron-containing compound; and
heating the mixture to cause thermal degradation of the mixture and form a porous boron nitride material.

The first and/or second nitrogen-containing compound are, in some instances, collectively referred to herein as “nitrogen precursors”. The boron-containing compound together with the nitrogen precursors are, in some instances, collectively referred to herein as “precursors”.

In a method of the invention, the mixture is heated (optionally under nitrogen) such that the precursors thermally degrade, boron nitride is formed and gaseous by-products are released. The method of the first aspect of the present invention may be useful for the production of porous boron nitride materials having useful properties in terms of porosity. In particular, it has been unexpectedly found that the type and extent of pores formed in the material can be tunable (i.e. selectively adjustable) based on the compounds in the mixture. Without wishing to be bound by theory, it is understood that said heating forms a boron nitride material and causes the release of gasses, which gasses give rise to porosity in the boron nitride material. The presence of first and second nitrogen-containing compounds enables thermal degradation and associated gas release to take place at different points during said heating (e.g. the first nitrogen-containing compound may degrade at a lower temperature than the second nitrogen-containing compound), influencing porosity in the boron nitride material.

The materials produced by the methods of the present invention may have porosity characteristics which have not been achievable to date. In particular, the materials of the invention may have novel characteristics in terms of total pore volume, micropore volume and/or mesopore volume levels.

The method of the invention does not rely on the use of a template. As a result, the present invention may offer a more straightforward and/or more economical technique for the production of porous boron nitride materials, in comparison to known methods using such templates. Additionally, since there is no requirement to utilise a template, the method may be useful for producing a porous boron nitride material which is substantially free of carbon impurities.

Accordingly, in some embodiments, the method does not involve a template, e.g. there may be no template in the mixture. There may be no porous template (e.g. a ceramic template, e.g. zeolite) in the mixture. There may be no porous template impregnated with one or more boron-containing compounds and/or one or more nitrogen-containing organic compounds in the mixture (which boron and nitrogen may be comprised within the same compound, such as a polymeric compound, e.g. polyborazylene).

The mixture may consist essentially of the precursors. As used herein, the phrase “consist essentially of” as applied to a designated component is used herein to denote that the designated component is present, and that one or more specific further components can be present, as long as those further components do not materially affect the essential characteristic(s) of the designated component. As applied to a mixture comprising precursors, for example, it will be appreciated that the “essential characteristic” of that mixture is to provide precursors for the formation of a porous boron nitride material. If the mixture is to “consist essentially of” such precursors, then the mixture should not comprise further components which may negatively impact such formation.

In the event that the method of the invention is for forming a material which is substantially free of carbon impurities and in which method the mixture consists essentially of the precursors, the mixture should not comprise further components which may yield a material which is not substantially free of carbon impurities, such as the template as defined above.

Suitably, the term “consist essentially of” may be interpreted such that the subject is primarily composed of a designated component (or components; i.e. there is a majority of that component(s)). Suitably, the subject comprises greater than or equal to about 85% of the designated component(s), such as greater than or equal to about 90%, such as greater than or equal to about 95%, such as greater than or equal to about 98%, such as greater than or equal to about 99%, such as about 100% (i.e. the subject consists of the designated component(s)).

In an embodiment, the nitrogen precursors and/or the boron-containing compound are not polymers. In an embodiment, each of the nitrogen precursors and/or the boron-containing compound each individually have a molecular weight less than 500, such as less than 250, such as less than 150.

The porous boron nitride material may be an amorphous and/or turbostratic porous boron nitride material, such as an amorphous porous boron nitride material.

At least one of the first and second nitrogen-containing compounds may be a nitrogen-containing organic compound. Both of the first and second nitrogen-containing compounds may be nitrogen-containing organic compounds.

The precursors may be selected such that, collectively, they thermally degrade to form boron nitride and release gaseous by-products. Each of the first and second nitrogen-containing compounds and the boron-containing compound in the mixture may consist of nitrogen atoms, carbon atoms, boron atoms, hydrogen atoms and other elements which form gaseous products as a result of said heating. All boron and nitrogen atoms present in the precursors may be either incorporated into the porous boron nitride material or evolve as gasses as said heating, and any non-boron and non-nitrogen atoms may be evolved as gasses. Herein it is to be understood that atoms not being incorporated into the material may react with other species and thereafter form gaseous products. By way of example, carbon atoms present in the first and/or second nitrogen-containing compounds and/or the boron-containing compound may react with oxygen (e.g. ambient oxygen or oxygen from a precursor in the mixture) and thereafter form gaseous carbon dioxide. The gaseous products may be selected from carbon monoxide, carbon dioxide, nitrous oxide, water, nitrogen, ammonia and isocyanic acid (HNCO).

It will be appreciated that selecting precursors in this way may yield a porous boron nitride material consisting essentially of boron, nitrogen and optionally oxygen atoms, meaning that impurities (i.e. non boron, nitrogen and optionally oxygen atoms) are not present in the material (since other atoms are evolved in gaseous form). Such embodiments may therefore provide the advantage that there is no need to wash the material in order to remove impurities, thus providing a more straightforward and/or economical method. Certain impurities are not removable by washing in any case. As a result, it will be appreciated that selecting precursors in this way may yield a more pure material than is hitherto known or achievable with techniques known in the art.

The first and second nitrogen-containing compounds should be understood to define different components (i.e. different chemical entities).

The method of the invention may be conducted with precursors which are readily and/or cheaply available. The method may, therefore, present a cost-effective and/or economical approach as compared with existing methods.

Each of the first and second nitrogen-containing compounds in the mixture may consist of nitrogen, boron, carbon, oxygen and/or hydrogen atoms; optionally nitrogen, carbon, oxygen and/or hydrogen atoms. By this, it will be appreciated that the first and second nitrogen-containing compounds must consist of at least nitrogen and may also consist of carbon, boron and/or hydrogen atoms.

Each of the first and/or second nitrogen-containing compounds may comprise one or more amino groups. The first and second nitrogen-containing compounds may be independently selected from urea (CO(NH₂)₂), melamine (1,3,5-triazine-2,4,6-triamine) and biuret (2-imidodicarbonic diamide), dicyandiamide (NH₂C(NH)NHCN). The first and second nitrogen-containing compounds may be independently selected from urea, melamine and biuret. In an embodiment, the first nitrogen-containing compound is urea and the second nitrogen-containing compound is biuret or melamine, optionally wherein the second nitrogen-containing compound is biuret.

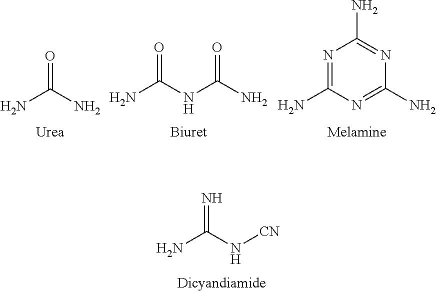

The boron-containing compound in the mixture may consist of nitrogen, boron, carbon, oxygen and/or hydrogen atoms; optionally nitrogen, boron, oxygen and/or hydrogen atoms; optionally boron, oxygen and/or hydrogen atoms. The boron-containing compound may be selected from boric acid (BOH₃), boron trioxide (B₂O₃) and ammonia borane (ammoniotrihydroborate/borazane, BH₃NH₃). In an embodiment, the boron-containing compound is boric acid.

The mixture may be provided by mixing (e.g. dissolving) the boron-containing compound with/in a solution (e.g. an aqueous solution) of one or both of the nitrogen precursors and then evaporating to remove liquid and thereby yield the mixture. Optionally, said evaporating is conducted by heating at a temperature elevated above room temperature (e.g. above about 50° C., such as about 85° C.). Optionally, the solution is a melamine solution.

The precursors may each be solids and the mixture may be provided by physically mixing (e.g. grinding) the solid precursors.

The first nitrogen-containing compound may have a thermal degradation temperature which is lower than the thermal degradation temperature of the second nitrogen-containing compound. Optionally, the thermal degradation temperature of said first nitrogen-containing compound is at least about 10° C. lower than the thermal degradation temperature of said second nitrogen-containing compound, optionally at least about 20° C. lower, optionally at least about 30° C. lower, optionally about at least 40° C. lower, optionally at least about 50° C. lower; optionally at least about 70° C. lower, optionally at least about 90° C. lower, optionally at least about 110° C. lower, optionally at least about 130° C. lower, optionally at least about 150° C. lower.

Without wishing to be bound by theory, it is believed that the porosity of the materials may be influenced through differences in degradation temperatures of the various precursors. This can be understood with reference to an embodiment of the invention in which the first nitrogen-containing compound is urea (degradation temperature about 150° C.) and the second nitrogen-containing compound is biuret (degradation temperature about 190° C.). In particular, it may be understood that urea would begin to degrade during said heating to a relatively low temperature (about 150° C.), whereas at relatively higher temperatures (about 190° C.), biuret begins to degrade. During degradation, gaseous products may be released (such as ammonia) that may react with the boron-containing compound (and/or its thermal degradation products) to form boron nitride. Alternatively or additionally, gases may be released and influence porosity in the boron nitride material. For reference, the degradation temperature of melamine is about 260° C.

Selection of specific first and second nitrogen-containing and boron-containing compounds may yield materials having a desired total pore volume, mesopore volume (diameter between about 2 and 50 nm) and/or micropore volume (diameter less than about 2 nm).

Said heating may be at or above a temperature sufficient to cause oxidation of elemental carbon during said heating. It will be appreciated that the exact temperature at which elemental carbon would be oxidised would depend on ambient conditions (e.g. pressure of a system in which the method/reaction is taking place). The heating may be at a temperature at or above the oxidation temperature of elemental carbon (e.g. the oxidation temperature under standard pressure of about 100 kPa; 1 bar).

It may be undesirable to have carbon-based impurities in the boron nitride material. By way of example, if a boron nitride material is intended to be used in a high temperature application, carbon-based impurities in the material may be caused to thermally decompose (e.g. oxidise) on heating, generating weaknesses (e.g. structural weaknesses) in the material. Heating at or above the temperatures in the preceding paragraph (and at temperatures discussed below) may be useful to remove such impurities and to ameliorate this issue.

Said heating may be below the crystallisation temperature of boron nitride. As is well known in the art, heating a material can cause the material to undergo a transition such that the resultant material becomes more crystalline (relative to the starting material). Heating to a temperature at or above the crystallisation temperature of boron nitride may have a negative impact on the porosity of the material.

Said heating may be to at least about 600° C., such as at least about 800° C. Said heating may be to below about 2000° C. Said heating may be to between about 800° C. and about 1200° C., optionally between about 1000° C. to about 1750° C., optionally between about 1000° C. to about 1600° C., optionally between about 1000° C. to about 1500° C., optionally between about 1000° C. to about 1100° C. or between about 1050° C. to about 1500° C. In an embodiment, said heating is to about 1050° C.

Said heating may be achieved by ramping the temperature of the mixture at a rate of about 1 to 20° C. per minute; optionally about 1 to 10° C. per minute; optionally about 2 to 8° C. per minute. Said heating may be achieved by ramping the temperature of the mixture at a rate of about 2.5° C. or about 5° C. or about 10° C. or about 15° C. per minute. Said heating may be achieved by ramping the temperature of the mixture from room temperature.

Said heating may be maintained for at least about 90 minutes; optionally at least about 120 minutes; optionally at least about 180 minutes; optionally at least about 210 minutes; optionally at least about 240 minutes. Said heating may be maintained for up to about 480 minutes; optionally up to about 420 minutes; optionally up to about 360 minutes; optionally up to about 300 minutes. In embodiments where ramping is involved, said heating may be maintained for the aforementioned time after said ramping is complete and the temperature of the mixture has reached a desired level.

Pore characteristics desired of a porous material may be different depending on the application envisaged. In gas separation, for example, it may be desirable to have pores of a particular size (e.g. a highly microporous material) to enable selective sorption of molecules of one gas over another. Other applications may require different porosity characteristics. In some embodiments, selection of the relative molar ratios of the compounds (precursors) in the mixture may yield materials having a desired total pore volume, mesopore volume (diameter between about 2 and 50 nm) and/or micropore volume (diameter less than about 2 nm).

The molar ratio of said first nitrogen-containing compound to said second nitrogen-containing compound in the mixture may be about 1:25 to about 25:1; optionally about 1:20 to about 20:1; optionally about 1:15 to about 15:1; optionally about 1:10 to about 10:1.

The molar ratio of said first nitrogen-containing compound to said boron-containing compound in the mixture may be at least about 1:1, optionally at least about 2:1, optionally at least about 3:1, optionally at least about 4:1; optionally at least about 5:1; and/or wherein the molar ratio of said second nitrogen-containing compound to said boron-containing compound is at least about 0.1:1, optionally at least about 0.25:1, optionally at least about 0.5:1, optionally at least about 1:1, optionally at least about 2:1, optionally at least about 3:1, optionally at least about 4:1, optionally at least about 8:1, optionally at least about 10:1.

It has been unexpectedly found that, by adjusting the molar ratios of the precursors, it is possible to achieve desirable porosity characteristics in the material produced by the methods of the present invention (i.e. it is possible to “tune” or selectively adjust the porosity characteristics of the materials produced). In particular, selection of the molar ratios of the precursors may yield materials having desirable and/or predetermined total pore volume, micropore volume and/or mesopore volume levels.

The molar ratio of:
said first nitrogen-containing compound to said second nitrogen-containing compound in the mixture; and/or
said first nitrogen-containing compound to said boron-containing compound in the mixture; and/or
said second nitrogen-containing compound to said boron-containing compound;
   may be selected to provide a predetermined total pore volume, and/or micropore volume and/or mesopore volume in the porous boron nitride material.

Said heating may be conducted under a substantially inert atmosphere, optionally an ammonia (NH₃) atmosphere, a hydrogen (H₂) atmosphere and/or a nitrogen (N₂) atmosphere, optionally an ammonia/nitrogen (NH₃/N₂) or a hydrogen/nitrogen (H₂/N₂) mixed atmosphere.

According to a second aspect of the present invention, there is provided a porous boron nitride material (optionally an amorphous and/or turbostratic porous boron nitride material, such as an amorphous porous boron nitride material) obtainable by the method according to the first aspect.

The porous boron nitride material may be substantially carbon-free. As used herein, “substantially carbon-free” may refer to the material comprising less than or equal to about 5% of carbon (such as an atomic percentage, based on the total number of atoms in the material; or a weight percentage, based on the total weight of the material), such as less than or equal to about 2%, such as less than or equal to about 1%, such as less than or equal to about 0.5%, such as less than or equal to about 0.1%, such as about 0%. Suitably, the surface carbon-content of a material can be measured by X-ray photoelectron spectroscopy (XPS), which measures the atomic percentage of elements in a sample. Alternatively, a carbon and oxygen analyser could be used to determine the carbon- and oxygen-content, on the basis of the total weight of a sample.

As mentioned above, the materials obtainable by the method according to the first aspect of the present invention may possess useful properties in terms of porosity, while remaining substantially free of impurities (such as carbon impurities). The material may further comprise oxygen as set out above.

The porous boron nitride material may be obtained by the method according to the first aspect.

The porous boron nitride material may have a surface area of about 900 m²/g or more as determined by BET (in the procedure generally outlined in Brunauer, S., P. H. Emmett, and E. Teller, Adsorption of gases in multimolecular layers. Journal of the American Chemical Society, 1938. 60(2): p. 309-319); optionally about 1100 m²/g or more; optionally about 1300 m²/g or more; optionally about 1500 m²/g or more; optionally about 1700 m²/g or more; optionally about 1900 m²/g or more; optionally about 2000 m²/g or more.

As used herein, the parameters BET surface area may be determined as follows, with reference to the equations below.

Nitrogen isotherms can be measured using a porosity analyser (Micromeritics 3Flex). In such an experiment, samples should be degassed overnight at 120° C. and about 20 pa (about 0.2 mbar), followed by degassing in-situ on the porosity analyser for 4 hours down to about 0.3 pa (about 0.0030 mbar). Measurements should be taken at −196° C.

The following equation can then be used to derive a plot, optionally conducted by the porosity analyser itself:

$$\frac{1}{[ ( \frac{{P}_{o}}{P} ) - 1 ]} = \frac{1}{{V}_{m} C} + \frac{C - 1}{{V}_{m} C} ( \frac{P}{{P}_{o}} )$$

### Where:

V: Volume of gas adsorbed (determined from the isotherm)
Vₘ: Volume corresponding to the monolayer coverage
P: Pressure of gas at equilibrium (determined from the isotherm)
P₀: Saturation pressure (determined from the isotherm)

### C: Constant

The software from the porosity analyser may be used to plot the equation rearranged as:

$$\frac{1}{V [ ( \frac{{P}_{o}}{P} ) - 1 ]} VS \frac{P}{{P}_{o}}$$

From this plot V, and C can be calculated (Vₘ being the Y-intercept and C being the slope of the curve), and the BET surface area may then be calculated as follows:

$${S}_{BET} = \frac{{V}_{m} {S}_{adsorptive} {N}_{avogardro}}{{V}_{M}}$$

### Where:

S_{adsorptive}: Cross sectional area of the adsorptive
V_{M}: Molar volume of the adsorptive at STP (22,414 cm³/mol)
N_{avogadro}: Avogadro constant

The BET surface area is calculated considering the pressure range in which the data points fit a linear data fit. The data points must satisfy the following criteria:
Pressure range: V[Pₒ-P] increases with P/Pₒ
The pressure corresponding to Vₘ should be within the pressure range selected
Negative intercepts are not acceptable

The porous boron nitride material may have a total pore volume of about 0.4 cm³/g or more; optionally about 0.6 cm³/g or more; optionally about 0.8 cm³/g or more; optionally about 1 cm³/g or more; optionally about 1.1 cm³/g or more.

The porous boron nitride material may have a total pore volume of up to about 10 cm³/g; optionally up to about 8 cm³/g; optionally up to about 6 cm³/g; optionally up to about 4 cm³/g; optionally up to about 2 cm³/g.

The total volume of pores may be calculated from the following equation, using the results of the nitrogen isotherm measurement noted above:

$${V}_{tot} = \frac{{P}_{standard} {V}_{absorbed} {V}_{M}}{RT}$$

### Where:

P_{standard}: standard pressure (10⁵ Pa)
V_{adsorbed}: volume of N₂ adsorbed at P/P₀=0.97 (determined from the isotherm)
V_{M}: molar volume of liquid N₂ at 77K (34.65 cm³/mol)
R: gas constant
T: standard temperature

The porous boron nitride material may have a total micropore volume (diameter less than about 2 nm) of about 0.2 cm³/g or more; optionally about 0.3 cm³/g or more; optionally about 0.5 cm³/g or more; optionally about 0.6 cm³/g or more; optionally about 0.7 cm³/g or more.

The porous boron nitride material may have a micropore volume of up to about 3 cm³/g; optionally up to about 2 cm³/g; optionally up to about 1 cm³/g, optionally up to about 0.75 cm³/g.

Micropore volume may be calculated using the Dubinin Radushkevich model and is based on the following equations, using results of the nitrogen isotherm measurement noted above:

$$log ( n ) = log ( {n}_{mic} ) - {D ( log ( \frac{P}{{P}_{0}} ) )}^{2}$$

### Where:

n: adsorption capacity at P
n_{mic}: adsorption capacity from the micropores
D: empirical constant
P: equilibrium pressure (determined from the isotherm)
P₀: saturation pressure (determined from the isotherm)

A plot of log(n) against (log(P/P₀))² enables a value for n_{mic} to be derived (from the Y intercept). Here, only the linear range of the plot is used.

Then the micropore volume V_{mic} may be determined from the following equation:

$${V}_{micropore} = \frac{{n}_{mic} M}{ρ}$$

Where M is the adsorbate molar mass and ρ the adsorbate density.

The porous boron nitride material may have a total mesopore volume (diameter between about 2 and 50 nm) of about 0.1 cm³/g or more; optionally about 0.2 cm³/g or more; optionally about 0.4 cm³/g or more; optionally about 0.5 cm³/g or more.

The porous boron nitride material may have a mesopore volume of up to about 3 cm³/g; optionally up to about 2.5 cm³/g; optionally up to about 2 cm³/g; optionally up to about 1 cm³/g.

Mesopore volume can be calculated by subtracting the micropore volume from the total pore volume.

Porous boron nitride materials have broad utility in a wide variety of applications, such as gas separation, liquid purification (such as water treatment) and other liquid separation techniques, air treatment, gas storage, drug delivery and catalysis. Additionally, such materials have a particularly high thermal stability (e.g. about 800-1000° C. in air and greater than about 1800° C., such as greater than about 2000° C. under an inert atmosphere). As a result, porous boron nitride materials may offer a useful substitute for carbonaceous porous materials (e.g. activated carbon) in applications where high temperatures are envisaged. One particular feature denoting suitability in this regard relates to the recyclability of boron nitride materials. In particular, substances sorbed to the boron nitride material can be burned away (e.g. thermally degraded, oxidised, etc., and the products evolved as gasses) by heating (optionally in, for example, an oxidising atmosphere such as air or oxygen), thereby regenerating the boron nitride material for further use. In contrast, carbonaceous materials readily undergo degradative processes (e.g. oxidation) under elevated temperature, and so heat-based recycling/regeneration techniques may be less useful.

According to a third aspect of the present invention, there is provided a method for separating a mixture of gasses, the method comprising:
exposing a mixture comprising a first gaseous component and a second gaseous component to a porous boron nitride material (optionally an amorphous and/or turbostratic porous boron nitride material, such as an amorphous porous boron nitride material) according to the second aspect of the present invention.

As mentioned above, the porosity (e.g. the total, micro, and/or meso porosity) of the materials of the present invention may be tunable to yield boron nitride materials having desirable porosity characteristics. Materials with certain porosity characteristics may be useful for preferential sorption of one gaseous component over another, meaning that such materials are particularly useful for the separation of mixtures of gasses. In particular, a gaseous component may have a higher affinity for a material with a given micro/mesoporosity, whereas another gaseous component may have a lower affinity for that material.

The first and/or second gaseous components may each independently be selected from nitrogen (N₂), carbon dioxide (CO₂), hydrogen (H₂) methane (CH₄), optionally nitrogen (N₂), carbon dioxide (CO₂) and methane (CH₄).

The mixture may be at a pressure elevated above about 100 kpa during said exposing; optionally above about 250 kpa; optionally above about 500 kpa; optionally above about 1000 kpa; optionally above about 1500 kpa; optionally above about 2000 kpa. In certain embodiments, materials may have a higher affinity for one gas over another gas at elevated pressure (relative to a comparative affinity at a lower pressure).

The mixture may have a temperature at or below about 40° C. during said exposing; optionally at or below about 25° C. during said exposing; optionally at or below about 10° C. during said exposing. In certain embodiments, materials may have a higher affinity for one gas over another gas at reduced temperature (relative to the affinity at a higher temperature).

According to a fourth aspect of the present invention, there is provided a use of a porous boron nitride material (optionally an amorphous and/or turbostratic porous boron nitride material, such as an amorphous porous boron nitride material) according to the second aspect of the present invention in the separation of a mixture comprising first and second gaseous components.

According to a fifth aspect of the present invention, there is provided a method for separating a mixture of a first liquid component and a second liquid component, the method comprising:
exposing a mixture comprising said first liquid component and said second liquid component to a porous boron nitride material (optionally an amorphous and/or turbostratic porous boron nitride material, such as an amorphous porous boron nitride material) according to the second aspect.

As mentioned above in relation to gas affinity, a given liquid component may have a higher affinity for the materials of the invention than another liquid component. Thus, the materials of the present invention may be used for the separation of mixtures of two or more liquid components.

The first liquid component may be substantially immiscible with said second liquid component. As used herein, the term “immiscible” may be understood to mean that a first specified liquid component does not form a homogenous solution upon mixture with a second liquid component. Suitably, immiscible may be understood to mean that a first specified liquid component has a solubility of less than about 500 mg/L in a second specified liquid component (i.e. 500 mg of the first component in one litre of a second component), such as less than about 250 mg/L, such as less than about 100 mg/L, such as less than about 50 mg/L, such as less than about 10 mg/L.

The first liquid component may be a hydrocarbon; optionally oil. Oil may be understood as being a liquid comprising a mixture of hydrocarbons. The first liquid component may be “crude oil” (petroleum), which is a naturally occurring liquid mixture of hydrocarbons, typically extracted from the ground.

The second liquid component may be water.

Porous boron nitride materials are particularly useful in the separation of oil-water mixtures (in which applications oil may be preferentially sorbed to the material, over water) owing to recyclability and hydrophobicity of certain boron nitride materials. In particular, since boron nitride has relatively high thermal resistance as described above, oil sorbed in/on the material can simply be burned away (e.g. thermally degraded, oxidised, etc.), yielding a regenerated material ready for further sorption.

According to a sixth aspect of the present invention, there is provided a use of a porous boron nitride material (optionally an amorphous and/or turbostratic porous boron nitride material, such as an amorphous porous boron nitride material) according to the second aspect of the present invention in the separation of a mixture comprising first and second liquid components.

Features described above in relation to the first, second, third, fourth, fifth and/or sixth aspects of the present invention also represent features of the each other aspect of the present invention (and vice versa) subject to a technical incompatibility that would prevent such a combination of preferred features. Furthermore, it will be evident to the skilled person that advantages set out above in respect of the first, second, third, fourth, fifth and/or sixth aspects of the present invention are also offered by each other aspect of the present invention (again and vice versa).

### EXAMPLES

The following examples are merely illustrative examples of the invention described herein, and are not intended to be limiting upon the scope of the invention.

A suitable technique for the synthesis of porous boron nitride materials, from a mixture of selected precursors, is as follows.

Selected nitrogen-containing and boron-containing precursors were physically mixed and ground. The mixture was placed in an alumina boat crucible and the ambient atmosphere was replaced with nitrogen during a purging step (2 h at 0.25 L/min N₂ to purge). The mixture was then heated in a furnace up to 1050° C. (10° C./min ramp rate) under an inert nitrogen atmosphere (N₂ gas flow 0.05 L/min). The temperature was held at 1050° C. for 3.5 hours and the furnace was then allowed to cool naturally under the nitrogen atmosphere.

### Example 1

Boron nitride materials were prepared in accordance with the suitable technique outlined above, selecting the following precursors in the mixture, in the following molar ratios:

| | Molar ratio | | | Molar ratio |
|---|---|---|---|---|
| | of boric | Molar ratio | Molar ratio | of |
| Sample Identifier | acid | of urea | of biuret | melamine |
| BN-U5 | 1 | 5 | 0 | 0 |
| BN-B2 | 1 | 0 | 2 | 0 |
| BN-BU0.5:5 | 1 | 5 | 0.5 | 0 |
| BN-BU1:5 | 1 | 5 | 1 | 0 |
| BN-BU2:5 | 1 | 5 | 2 | 0 |
| BN-BU3:5 | 1 | 5 | 3 | 0 |
| BN-BU4:5 | 1 | 5 | 4 | 0 |
| BN-BU8:5 | 1 | 5 | 8 | 0 |
| BN-M0.25 | 1 | 0 | 0 | 0.25 |
| BN-M0.5 | 1 | 0 | 0 | 0.5 |
| BN-M1 | 1 | 0 | 0 | 1 |
| BN-MU0.25:5 | 1 | 5 | 0 | 0.25 |
| BN-MU0.5:5 | 1 | 5 | 0 | 0.5 |
| BN-MU1:5 | 1 | 5 | 0 | 1 |

In experiments involving melamine, mixing involved dissolving boric acid in an aqueous melamine solution, and the water in the solution being evaporated to obtain a solid. The solid was then dried overnight at 85° C. prior to purging and heating as set out above.

In all other experiments, the precursors were physically mixed and ground prior to purging and heating as set out above.

### Example 2

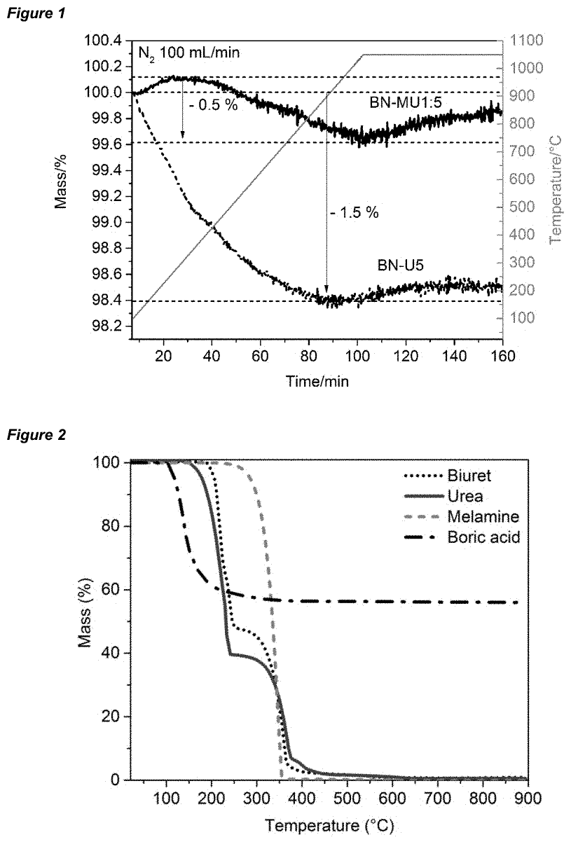

The thermal stability of samples BN-MU1:5 and BN-U5, and the materials for certain compounds suitable for use as precursors (i.e. the nitrogen-containing compounds and the boron-containing compound) were analysed using a thermogravimetric analyser (TGA) Netzsch TG209 F1 Libra from room temperature (about 20° C.) to 900° C. (10° C./min ramp rate) under nitrogen gas flow (0.1 L/min). The results are shown in FIGS. 1 and 2 below.

In FIG. 2, urea is represented by the lowermost dataset (referring to the ordering as seen from a temperature of 300° C.), biuret the next lowest dataset, boric acid the next and melamine the uppermost.

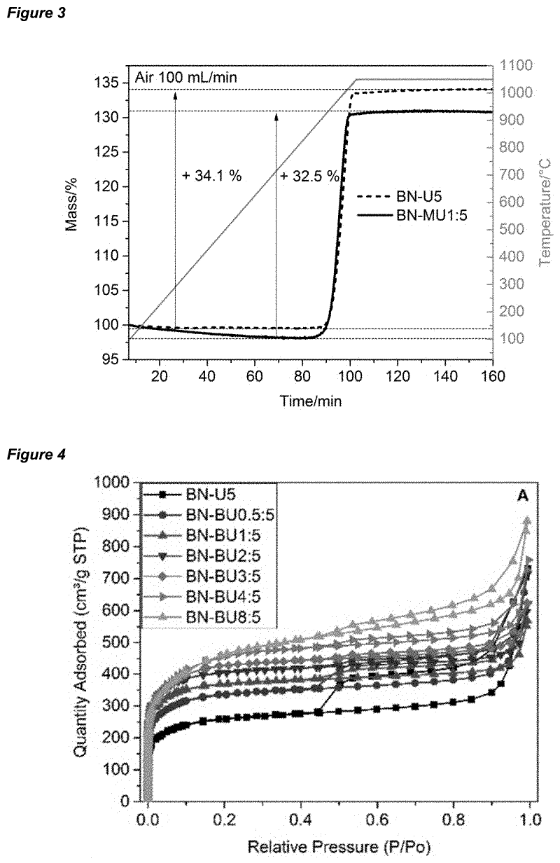

The thermal stability of samples BN-MU1:5 and BN-U5 were then analysed under air, using a thermogravimetric analyser (TGA) Netzsch TG209 F1 Libra, from room temperature (about 20° C.) to 900° C. (10° C./min ramp rate) under air flow (0.1 L/min). The results are shown in FIG. 3 below.

### Example 3

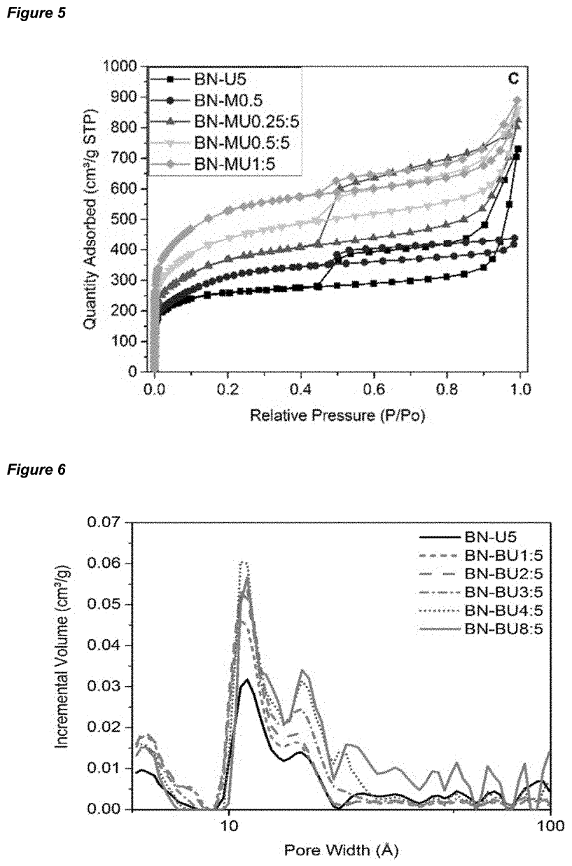

Nitrogen isotherms were measured using a porosity analyser (Micromeritics 3Flex). Samples prepared in accordance with Example 1 above were degassed overnight at 120° C. and about 20 pa (about 0.2 mbar). They were then degassed in-situ on the porosity analyser for 4 hours down to about 0.3 pa (about 0.0030 mbar). Measurements were taken at −196° C. The results are shown in FIGS. 4 and 5.

In FIG. 4, BN-U5 is represented by the lowermost dataset (as seen from the left hand side of the figure, e.g. referring to the ordering as seen from a relative pressure [P/P₀] of about 0.4), BN-BU0.5:5 is represented by the next lowest dataset, BN-BU1:5 the next, BN-BU2:5 the next, BN-BU3:5 the next, BN-BU4:5 the next and with BN-BU8:5 as the uppermost dataset.

“STP” refers to standard temperature and pressure (i.e. 273.15 K, 0° C., 32° F.; and an absolute pressure of 101.325 kPa, 14.7 psi, 1.00 atm, 1.01325 bar).

As can be seen, for the samples comprising biuret and urea, the sample with a molar ratio for biuret to urea of 8:5 (sample BN-BU8:5) was able to adsorb the highest quantity of nitrogen for a given relative pressure. Generally, samples prepared from mixtures having higher amounts of biuret relative to urea (i.e. in terms of the molar ratio) had higher capacity for nitrogen adsorption.

In FIG. 5, BN-U5 is represented by the lowermost dataset (as seen from the left hand side of the figure, e.g. referring to the ordering as seen from a relative pressure [P/P₀] of about 0.3), BN-M0.5 is represented by the next lowest dataset, BN-MU0.25:5 the next, BN-MU0.5:5 the next and BN-MU1:5 as the uppermost dataset.

For the samples comprising melamine and urea, the sample with a molar ratio for melamine to urea of 1:5 (sample BN-MU1:5) was able to adsorb the highest quantity of nitrogen for a given relative pressure. Generally, samples prepared from mixtures having higher amounts of melamine relative to urea (i.e. in terms of the molar ratio) had higher capacity for nitrogen adsorption.

### Example 4

The surface areas of the samples were calculated using the Brunauer-Emmett-Teller (BET) method (in accordance with the procedure outlined in Brunauer, S., P. H. Emmett, and E. Teller, Adsorption of gases in multimolecular layers. Journal of the American Chemical Society, 1938. 60(2): p. 309-319). The results are shown in the table below.

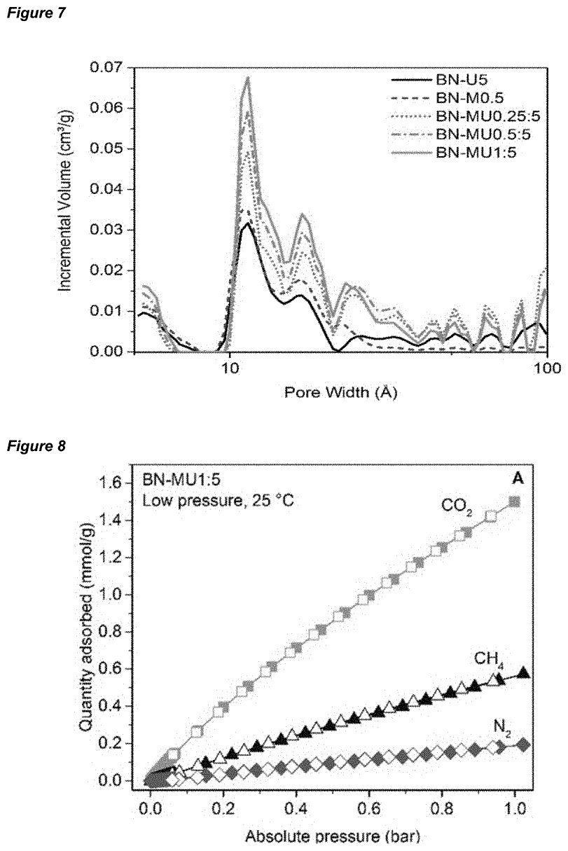

FIGS. 6 and 7 show the pore size distribution, with a summary in the table below.

| Sample | S_{BET} | Vₜₒₜ | V_{micro} | Vₘₑₛₒ | |
|---|---|---|---|---|---|
| identifier | (m²/g) | (cm³/g) | (cm³/g) | (cm³/g) | % mic |
| BN-U5 | 945 | 0.85 | 0.33 | 0.53 | 38.80% |
| BN-B2 | 936 | 0.59 | 0.33 | 0.26 | 55.90% |
| BN-BU0.5:5 | 1263 | 1.02 | 0.46 | 0.56 | 45.10% |
| BN-BU1:5 | 1387 | 0.72 | 0.53 | 0.19 | 73.60% |
| BN-BU2:5 | 1525 | 0.77 | 0.58 | 0.19 | 75.30% |
| BN-BU3:5 | 1564 | 0.82 | 0.6 | 0.22 | 73.20% |
| BN-BU4:5 | 1599 | 0.92 | 0.64 | 0.28 | 69.60% |
| BN-BU8:5 | 1602 | 1.09 | 0.54 | 0.55 | 49.50% |
| BN-M0.5 | 1089 | 0.54 | 0.43 | 0.11 | 79.60% |
| BN-MU0.25:5 | 1345 | 1.09 | 0.54 | 0.55 | 49.6% |
| BN-MU0.5:5 | 1600 | 1.11 | 0.64 | 0.47 | 58.00% |
| BN-MU1:5 | 1924 | 1.2 | 0.78 | 0.42 | 65.00% |

In the table above, S_{BET} means the BET surface area, Vₜₒₜ means the total pore volume, V_{micro} means the micropore volume Vₘₑₛₒ means the mesopore volume, and % mic means the percentage of micropores (relative to mesopores).

Non-local density functional theory (NLDFT) for carbons with slit pores at 77 K in N₂ was adopted for pore size distribution measurements (using the SAIEUS program provided with the 3Flex porosity analyser). The NLDFT model for carbons with slit pores at 77 K in N2 (http://www.nldft.com/) was adopted.

For the samples comprising biuret and urea, the sample with a molar ratio for biuret to urea of 8:5 (sample BN-BU8:5) had the highest surface area. Generally, samples prepared from mixtures having higher amounts of biuret relative to urea (i.e. in terms of the molar ratio) had higher surface areas.

For the samples comprising melamine and urea, the sample with a molar ratio for melamine to urea of 1:5 (sample BN-MU1:5) had the highest surface area. Generally, samples prepared from mixtures having higher amounts of melamine relative to urea (i.e. in terms of the molar ratio) had higher surface areas.

In general, samples having higher ratios of biuret to urea, or melamine to urea, had higher total surface area.

### Example 5

Low pressure (about 100 kpa; about 1 bar) gas sorption tests were performed on a Micromeritics 3Flex sorption analyzer at 25° C., using a water bath to control the temperature. Samples (each about 100 mg) prepared in accordance with Example 1 above were degassed overnight at 120° C. at about 20 pa (about 0.2 mbar) pressure and then degassed in-situ for 4 hours down to about 0.3 pa (about 0.0030 mbar), before testing. The samples were tested in the following order: nitrogen, methane, carbon dioxide; and the in-situ degas step was repeated between each test. The results are summarised in the table below, and shown in FIG. 8 for sample BN-MU1:5.

| | N₂ adsorbed | CH₄ adsorbed | CO₂ adsorbed |
|---|---|---|---|
| Sample | (mmol/g) | (mmol/g) | (mmol/g) |
| BN-U5 | 0.13 | 0.39 | 0.7 |
| BN-BU0.5:5 | 0.18 | 0.48 | 1.2 |
| BN-BU1:5 | 0.18 | 0.56 | 1.6 |
| BN-BU2:5 | 0.17 | 0.5 | 1.5 |
| BN-BU3:5 | 0.2 | 0.55 | 1.5 |
| BN-BU4:5 | 0.16 | 0.45 | 1.4 |
| BN-BU8:5 | 0.21 | 0.59 | 1.6 |
| BN-M0.5 | 0.17 | 0.52 | 1.3 |
| BN-MU0.25:5 | 0.16 | 0.45 | 1.1 |
| BN-MU0.5:5 | 0.18 | 0.52 | 1.3 |
| BN-MU1:5 | 0.19 | 0.57 | 1.5 |

### Example 6

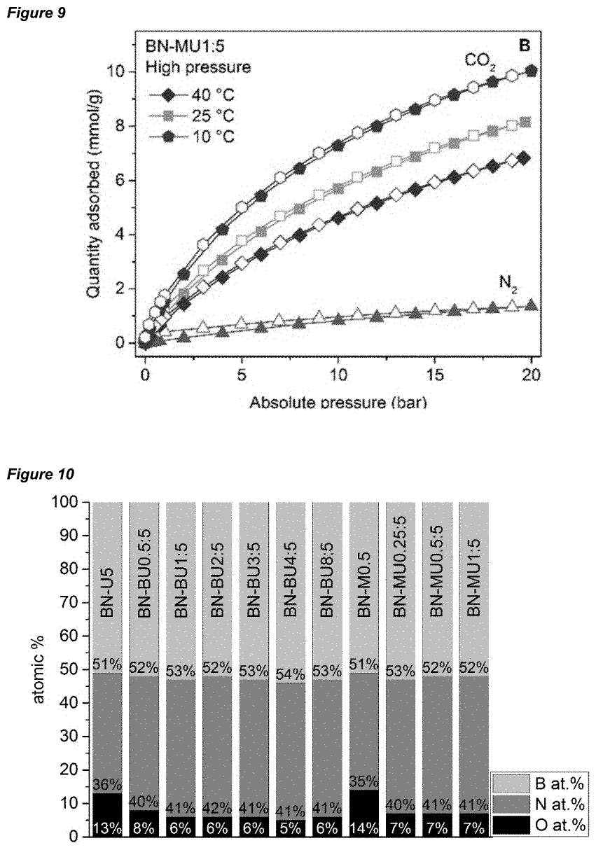

High pressure (about 2000 kpa; 20 bar) gas sorption tests were performed on an Intelligent Gravimetrical analyzer (IGA; Hiden Isochema). Sample BN-MU1:5 (about 50 mg) was degassed in-situ at 120° C. and about 0.1 mbar for 4 hours prior to testing. Nitrogen and carbon dioxide sorption tests were performed at different temperatures (10, 25, 40° C.), with the sample being degassed at 60° C. for 3 hours at about 30 pa (about 0.3 mbar) between each test. The results are shown in FIG. 9, and summarised in the table below.

| Temp (° C.) | N₂ sorption (mmol/g) | CO₂ sorption (mmol/g) |
|---|---|---|
| 10 | 1.4 | 10.0 |
| 25 | 1.3 | 8.1 |
| 40 | 1.2 | 6.8 |

### Example 7

Surface elemental analysis was performed with X-Ray Photoelectron Spectroscopy (XPS). Samples were analysed using a Thermo Scientific K-Alpha⁺ X-ray Photoelectron Spectrometer equipped with a MXR3 Al Kα monochromated X-ray source (hv=1486.6 eV). X-ray gun power was set to 72 W (6 mA and 12 kV). All high resolution spectra (B 1s, N 1s, C 1s, and O 1s) were acquired using 20 eV pass energy, 0.1 eV step size. The samples were ground and mounted on the XPS sample holder using conductive carbon tape. Thermo Avantage was used to analyse the data. The XPS spectra were shifted to align the peak for adventitious carbon (C—C) at 285.0 eV. The results are shown in FIG. 10 (percentages refer to relative atomic percentages).

### Example 8

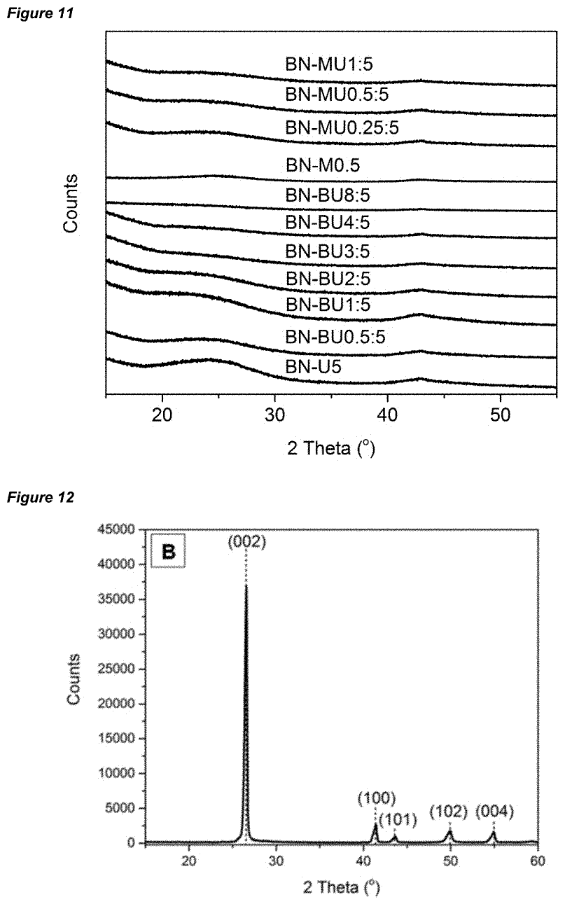

Powder X-ray diffraction (XRD) was performed on samples prepared in accordance with Example 1, and a reference sample of commercially available hexagonal boron nitride (h-BN) using an X-ray diffractometer (PANalytical X'Pert PRO) in reflection mode. The operating conditions included an anode voltage of 40 kV and an emission current of 40 mA using a monochromatic Cu Kα radiation (λ=1.54178 Å). The results are shown in FIG. 11 (samples from Example 1) and FIG. 12 (commercial hexagonal boron nitride).

As can be seen, samples prepared in accordance with Example 1 above were substantially amorphous, as indicated by the broad peaks at about 25.5°, as compared with the spectra for crystalline hexagonal boron nitride in FIG. 12.

### Example 9

Skeletal (i.e. absolute) densities of BN-U5 and BNMU1:5 were calculated using AccuPyc II 1340 from Micromeritics with helium probe at 25° C. About 0.1 g of each sample was used for the analysis in a 1 cm³ chamber. The densities are reported in the table below and correspond to the average of 10 measurements.

| | Average density | Standard deviation |
|---|---|---|
| Sample identifier | (g/cm³) | (g/cm³) |
| BN-U5 | 2.1769 | 0.0147 |
| BN-MU1:5 | 2.1169 | 0.0121 |

### Example 10

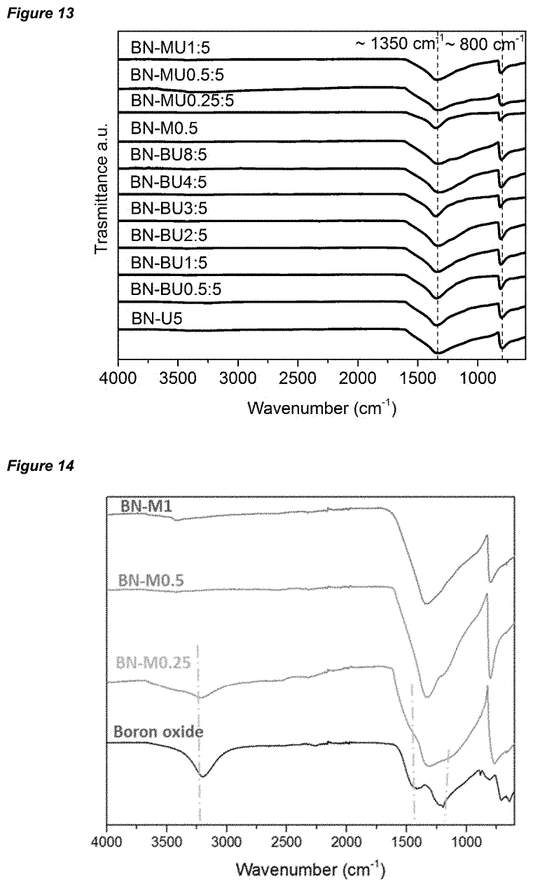

FT-IR analyses were conducted on samples produced in accordance with Example 1 above, and for boron oxide. The results are shown FIGS. 13 and 14.

### Example 11

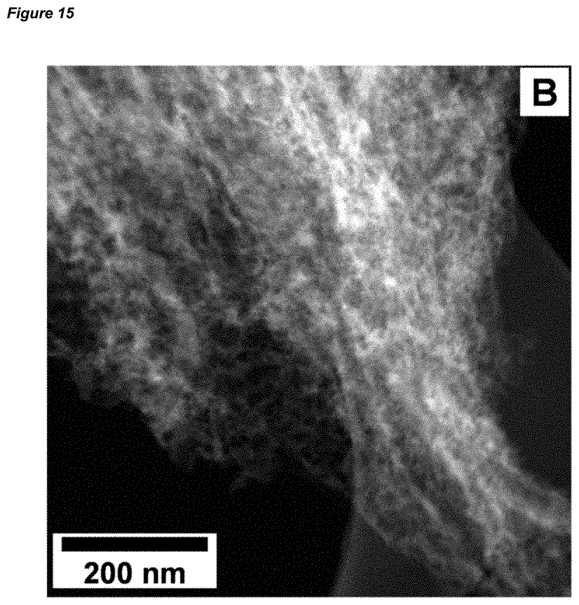

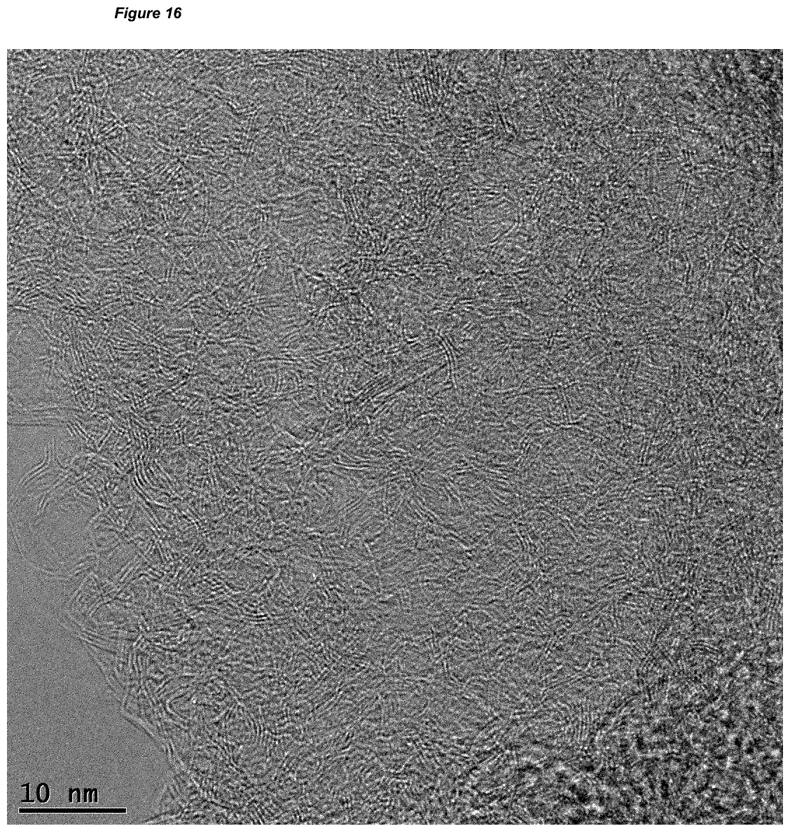

Scanning/Transmission electron microscopy (STEM) analysis was conducted using a Titan microscope commercially available from FEI. The results are shown FIG. 15 (dark field STEM). As can be seen, the porous material of the invention is highly porous with sparse density and many open pores. Closer inspection with high resolution scanning (FIG. 16) reveals that the material is an amorphous/turbostratic material.

### Example 12

Four further boron nitride materials comprising melamine and urea, having a molar ratio of boric acid to melamine to urea of 1:1:5, were prepared in accordance with the suitable technique outlined above, but using variable ramp rates (between 2.5 and 15° C./min ramp rate).

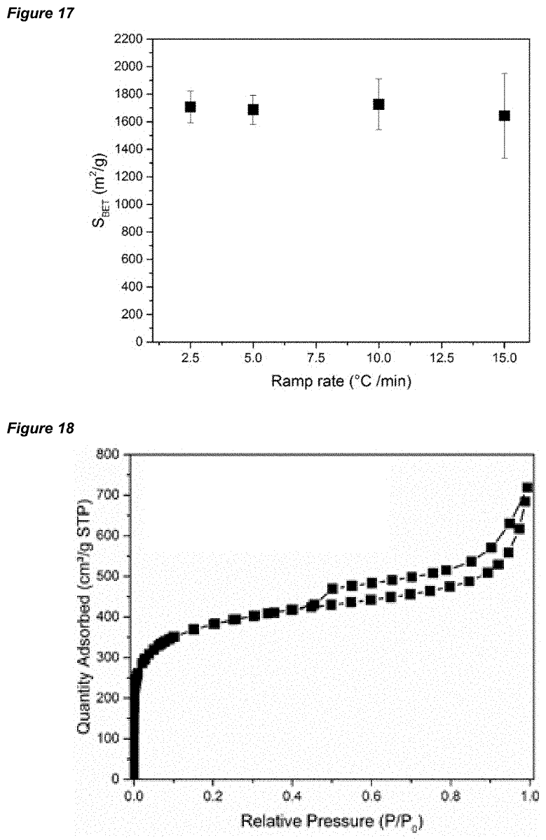

Surface area tests were performed in accordance with Example 4 above. The results are shown in FIG. 17.

### Example 13

A further boron nitride material comprising melamine and urea, having a molar ratio of boric acid to melamine to urea of 1:1:5, was prepared in accordance with the suitable technique outlined above, but using a furnace heated to 800° C. (10° C./min ramp rate).

A nitrogen isotherm was performed in accordance with Example 3 above. The results are shown in FIG. 18.

Surface area tests were performed in accordance with Example 4 above. The results are shown in the table below.

| S_{BET} | Vₜₒₜ | V_{micro} | Vₘₑₛₒ | |
|---|---|---|---|---|
| (m²/g) | (cm³/g) | (cm³/g) | (cm³/g) | % mic |
| 1418 | 0.96 | 0.54 | 0.42 | 56.50% |

Fourier-transform infrared spectroscopy (FTIR) analyses indicated that the sample contained impurities. It is believed the level of impurities in the sample may have resulted from the relatively low temperature employed during the heating stage.

### Example 14

A further boron nitride material comprising melamine and urea, having a molar ratio of boric acid to melamine to urea of 1:1:5, was prepared in accordance with the suitable technique outlined above, using a furnace heated to 1050° C. (10° C./min ramp rate), but where the temperature was held at 1050° C. for 2 hours.

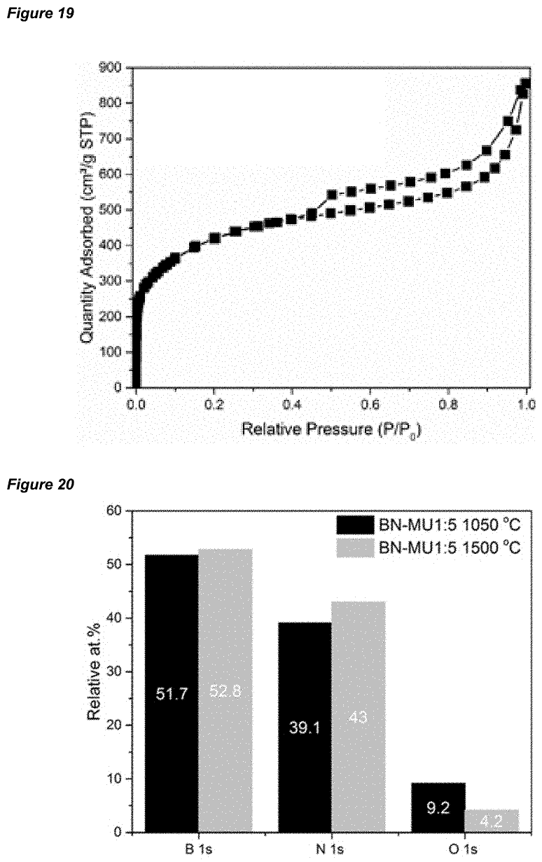

A nitrogen isotherm was performed in accordance with Example 3 above. The results are shown in FIG. 19.

Surface area tests were performed in accordance with Example 4 above. The results are shown in the table below.

| S_{BET} | Vₜₒₜ | V_{micro} | Vₘₑₛₒ | |
|---|---|---|---|---|
| (m²/g) | (cm³/g) | (cm³/g) | (cm³/g) | % mic |
| 1522 | 0.98 | 0.6 | 0.38 | 61.30% |

### Example 15

A further boron nitride material comprising melamine and urea, having a molar ratio of boric acid to melamine to urea of 1:1:5, was prepared in accordance with the suitable technique outlined above, but using a furnace heated to 1500° C.

Surface elemental analysis was performed with X-Ray Photoelectron Spectroscopy (XPS) on the sample and compared against an equivalent sample prepared using a furnace heated to 1050° C. The results are shown in FIG. 20 (percentages refer to relative atomic percentages).

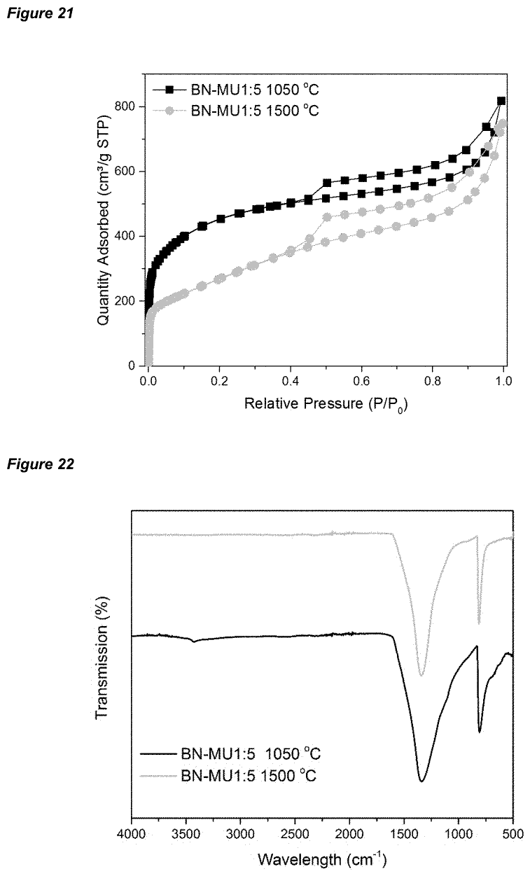

A nitrogen isotherm was performed in accordance with Example 3 above. The results are shown in FIG. 21.

Surface area tests were performed in accordance with Example 4 above. The results are shown in the table below.

| S_{BET} | Vₜₒₜ | V_{micro} | Vₘₑₛₒ | |
|---|---|---|---|---|
| (m²/g) | (cm³/g) | (cm³/g) | (cm³/g) | % mic |
| 980 | 1.01 | 0.43 | 0.58 | 42.6% |

Fourier-transform infrared spectroscopy (FTIR) analyses were performed on the sample and compared against an equivalent sample prepared using a furnace heated to 1050° C. The results are shown in FIG. 22.

1. A method for producing a porous boron nitride material, the method comprising:
providing a mixture comprising a first nitrogen-containing compound, a second nitrogen-containing compound and a boron-containing compound; and
heating the mixture to cause thermal degradation of the mixture and form a porous boron nitride material.

2. The method according to claim 1, wherein the porous boron nitride material is an amorphous and/or turbostratic porous boron nitride material.

3. The method according to claim 1, wherein at least one of the first and/or second nitrogen-containing compound is a nitrogen-containing organic compound.

4. The method according to claim 1, wherein each of the first and second nitrogen-containing compounds in the mixture consist of nitrogen, boron, carbon, oxygen and/or hydrogen atoms.

5. The method according to claim 1, wherein the first and/or second nitrogen-containing compounds are independently selected from urea, melamine, biuret, dicyandiamide, ammonia and ammonia borane.

6. (canceled)

7. The method according to claim 1, wherein the boron-containing compound in the mixture consists of nitrogen, boron, carbon, oxygen and/or hydrogen atoms.

8. The method according to claim 1, wherein the boron-containing compound is selected from boric acid, boron trioxide and ammonia borane.

9. The method according to claim 1, wherein each of the first and second nitrogen-containing compounds and the boron-containing compound in the mixture consist of nitrogen atoms, carbon atoms, boron atoms, and other elements which form gaseous products as a result of said heating, and wherein the gaseous products are selected from carbon monoxide, carbon dioxide, nitrous oxide water, nitrogen, ammonia and isocyanic acid.

10. (canceled)

11. The method according to claim 1, wherein the first nitrogen-containing compound has a thermal degradation temperature which is lower than the thermal degradation temperature of the second nitrogen-containing compound.

12. (canceled)

13. (canceled)

14. The method according to claim 1, wherein said heating is to a temperature of at least about 600° C. and below the crystallisation temperature of boron nitride.

15. The method according to claim 1, wherein said heating is achieved by ramping the temperature of the mixture at a rate of about 1 to 20° C. per minute.

16. (canceled)

17. (canceled)

18. The method according to claim 1, wherein the molar ratio of said first nitrogen-containing compound to said second nitrogen-containing compound in the mixture is about 1:25 to about 25:1 and wherein the molar ratio of said first nitrogen-containing compound to said boron-containing compound in the mixture is at least about 1:1

19. (canceled)

20. The method according to claim 1, wherein said heating is conducted under a substantially inert atmosphere.

21. The method according to claim 1, wherein there is no polymeric template in the mixture.

22. A porous boron nitride material obtainable by the method according to claim 1.

23. The porous boron nitride material according to claim 22, wherein the material is substantially carbon-free.

24. The porous boron nitride material according to claim 22, wherein the material has a surface area of about 900 m²/g or more.

25. The porous boron nitride material according to claim 22, wherein the material has a total pore volume of about 0.4 cm³/g or more.

26. The porous boron nitride material according to claim 22, wherein the material has a total micropore volume of about 0.2 cm³/g or more.

27. The porous boron nitride material according to claim 22, wherein the material has a total mesopore volume of about 0.1 cm³/g or more.

28. A method for separating a mixture of gasses, the method comprising:
exposing a mixture comprising a first gaseous component and a second gaseous component to a porous boron nitride material according to claim 22.

29. The method for separating a mixture of gasses according to claim 28, wherein the first and second gaseous components are each independently selected from nitrogen (N₂), carbon dioxide (CO₂), methane (CH₄) and hydrogen (H₂).

30. The method for separating a mixture of gasses according to claim 28, wherein the mixture is at a pressure elevated above about 100 kpa during said exposing.

31. The method for separating a mixture of gasses according to claim 28, wherein the mixture is at a temperature at or below about 40° C. during said exposing.

32. (canceled)

33. A method for separating a mixture of a first liquid component and a second liquid component, the method comprising:
exposing a mixture comprising said first liquid component and said second liquid component to a porous boron nitride material according to claim 22.

34. The method for separating a mixture according to claim 33, wherein the first liquid component is substantially immiscible with said second liquid component.

35. The method for separating a mixture according to claim 33, wherein the first liquid component is a hydrocarbon and wherein the second liquid component is water.

36. (canceled)

37. (canceled)

38. (canceled)
